(19) United States
(12) Patent Application Publication
(10) Pub. No.: US 2026/0205189 A1
(43) Pub. Date: Jul. 16, 2026

(54) COMMUNICATION METHOD AND APPARATUS

(71) Applicant: HUAWEI TECHNOLOGIES CO., LTD., Shenzhen (CN)

(72) Inventors: Tianhang Yu, Hangzhou (CN); Yunfei Qiao, Hangzhou (CN); Yu Wang, Hangzhou (CN); Rong Li, Shanghai (CN); Jun Wang, Hangzhou (CN)

(21) Appl. No.: 19/561,776

(22) Filed: Mar. 10, 2026

Related U.S. Application Data
(63) Continuation of application No. PCT/CN2024/121086, filed on Sep. 25, 2024.

(30) Foreign Application Priority Data
Sep. 26, 2023 (CN) 202311260372.3

(51) Int. Cl. H04B 7/06; H04L 27/26

(52) U.S. Cl. CPC H04B 7/06952; H04L 27/261

(57) ABSTRACT

A communication method performed by a communication apparatus includes receiving first indication information broadcast by a network device. The first indication information indicates configuration information of a first reference signal that corresponds to a first beam and information about a first antenna port number that corresponds to the first beam. The communication method also includes determining the first reference signal based on the first indication information.

### CROSS-REFERENCE TO RELATED APPLICATIONS

This application is a continuation of International Application No. PCT/CN2024/121086, filed on Sep. 25, 2024, which claims priority to Chinese Patent Application No. 202311260372.3, filed on Sep. 26, 2023. The disclosures of the aforementioned applications are hereby incorporated by reference in their entireties.

### TECHNICAL FIELD

Embodiments of this disclosure relate to the field of communication technologies, and in particular, to a communication method and apparatus.

### BACKGROUND

In a 5th generation (5G) mobile communication new radio (NR) standard, reference signals used for downlink channel state measurement are defined, for example, a demodulation reference signal (DMRS), a channel state information reference signal (CSI-RS), and a phase tracking reference signal (PTRS). Configuration information of all the reference signals is user equipment (UE)-dedicated information, and a network indicates the configuration information to UE through radio resource control (RRC) signaling. The configuration information of the reference signal is indicated in the RRC signaling for each UE, and signaling indication overheads are high.

### SUMMARY

This disclosure provides a communication method and apparatus, to reduce indication overheads of a reference signal.

According to a first aspect, this disclosure provides a communication method. The method may be performed through interaction between a terminal and a network device. The terminal may be understood as the terminal itself, or may be understood as a chip disposed inside the terminal. This is not limited herein. The terminal may be a mobile phone, a vehicle-mounted device, an internet of things device, or the like. The network device may be understood as the network device itself, or may be understood as a chip disposed inside the network device. The network device may be a base station, a satellite, an access point, or the like. This is not limited herein. The method may be applied to a 5G communication system or a communication system above 5G, or may be applied to a non-terrestrial communication system. This is not limited in this disclosure. During actual applications, execution is as follows.

The network device determines first indication information, where the first indication information indicates configuration information of a first reference signal that corresponds to a first beam and information about a first antenna port number that corresponds to the first beam. The network device broadcasts the first indication information. After receiving the first indication information, the terminal determines the first reference signal based on the first indication information.

In this disclosure, the network device sends the first indication information to the terminal through broadcast. The first indication information is beam-level indication information, and is not separately indicated for each terminal. In this manner, configuration information of a reference signal does not need to be configured in RRC signaling for each terminal, and therefore reference signal indication overheads can be reduced.

In an optional manner, the terminal determines, based on a resource offset between a resource allocated to the terminal and a reference resource, a subsequence that is of the first reference signal and that is occupied by the terminal, where the reference resource is a common reference point of a resource block grid or a starting position of a bandwidth part (BWP).

In this disclosure, after receiving the first indication information, the terminal determines to reorder the subsequence of the first reference signal based on the resource offset between a reference resource and a resource allocated, to ensure that a subsequence of a reference signal allocated to the terminal with a port orthogonal to a first antenna port is orthogonal to the subsequence of the first reference signal in an overlapping part.

In an optional manner, the network device further broadcasts second indication information, where the second indication information indicates the terminal to determine a sequence of a reference signal based on a reference resource offset, and the reference resource is a common reference point of a resource block grid or a starting position of a BWP; and the terminal receives the second indication information broadcast by the network device, and determines, based on a resource offset between a resource allocated to the terminal and a reference resource, a subsequence that is of the first reference signal and that is occupied by the terminal.

In this disclosure, after receiving the second indication information that indicates the terminal to determine the sequence of a reference signal based on the reference resource offset, the terminal determines to reorder the subsequence of the first reference signal based on the resource offset between a reference resource and a resource allocated, to ensure that a subsequence of a reference signal allocated to the terminal with a port orthogonal to a first antenna port is orthogonal to the subsequence of the first reference signal in an overlapping part.

In an optional manner, the network device determines a resource offset, where the resource offset indicates a resource offset between a common reference point of a resource block grid of the first beam and a common reference point of a resource block grid of the second beam, or a resource offset between a starting position of a BWP of the first beam and a starting position of a BWP of the second beam, and the first beam and the second beam have different carrier bandwidths, or the first beam and the second beam have different BWPs. The network device broadcasts third indication information, where the third indication information indicates the resource offset. The terminal receives the third indication information broadcast by the network device, and determines, based on the third indication information and a resource allocated to the terminal, a subsequence that is of the first reference signal and that is occupied by the terminal.

In this disclosure, after receiving the third indication information indicating the resource offset, the terminal determines to reorder the subsequence of the first reference signal based on the resource offset and a resource allocated, to ensure that a subsequence of a reference signal allocated to the terminal with a port orthogonal to a first antenna port is orthogonal to the subsequence of the first reference signal in an overlapping part.

In an optional manner, the first indication information is carried by using the following signaling:
system information block (SIB) or downlink control information (DCI).

In this disclosure, the first indication information, the second indication information, and the third indication information may be carried by using same signaling. This is not limited herein. In one embodiment, a field may be added to the SIB for indication, or a reserved field of the SIB may be used for indication, or an existing field may be reused under some prerequisites. This is not limited herein. Compared with a case in which configuration information of a reference signal is directly indicated to terminals one by one by using RRC signaling, indicating each piece of indication information by using the foregoing information can reduce indication overheads.

In an optional manner, the network device broadcasts fourth indication information, where the fourth indication information indicates a configuration parameter of a beam-level update period of the signaling. Correspondingly, the terminal receives the fourth indication information broadcast by the network device.

In an optional manner, the beam-level update period of the signaling is determined by using the following formula:

$$m = M * D / N$$

m represents an update period, m is in a unit of a quantity of radio frames rf, M represents a beam-level update period coefficient, a value of M is 2^{X1}, X1 is an integer greater than 1, D represents a beam-level paging cycle, a value of D is 32 rf, a value of N is 2^{L}, and L is a positive integer.

In an optional manner, the beam-level update period of the signaling is determined by using the following formula:

$$m = M * D$$

m represents an update period, m is in a unit of a quantity of radio frames, M represents a beam-level update period coefficient, a value of M is 1 or ½^{L}, D represents a beam-level paging cycle, and a value of D is 32 rf; or a value of M is 2^{X1}, X1 is an integer greater than 1, D represents a beam-level paging cycle, and a value of D is at least one of the following:
1 rf, 2 rf, 4 rf, 8 rf, or 16 rf.

The foregoing method is used to determine the beam-level update period of the signaling, which can increase a signaling update frequency, and improve flexibility of a reference information configuration.

In an optional manner, the first reference signal is a DMRS, a CSI-RS, or a PTRS.

In an optional manner, the first indication information further indicates configuration information of a second reference signal that corresponds to the first beam and information about a second antenna port number that corresponds to the first beam.

If one beam corresponds to N types of configuration information and antenna port numbers of a reference signal, for example, N=2, in one beam, a part of terminals use a first type of configuration information and information about an antenna port number of a reference signal, and other terminals use a second type of configuration information and information about an antenna port number of a reference signal. In this way, configurations of two types of reference signals may be simultaneously broadcast in a broadcast signal. In terminal-level signaling (such as RRC signaling or DCI), only one bit indicates an index of a reference signal configuration, to reduce terminal-level signaling indication overheads.

According to a second aspect, an embodiment of this disclosure provides a communication apparatus. The communication apparatus may be a terminal (a network device) or a chip disposed inside the terminal (a chip disposed inside the network device). The communication apparatus has functions of implementing the first aspect. For example, the communication apparatus includes corresponding modules, units, or means for performing the steps in the first aspect. The functions, units, or means may be implemented by using software or hardware, or may be implemented by hardware executing corresponding software.

In a possible design, the communication apparatus includes a processing unit and a transceiver unit. The transceiver unit may be configured to send and receive a signal, to implement communication between the communication apparatus and another apparatus. For example, the transceiver unit is configured to receive configuration information from a terminal. The processing unit may be configured to perform some internal operations of the communication apparatus. The transceiver unit may be referred to as an input/output unit, a communication unit, or the like, and the transceiver unit may be a transceiver. The processing unit may be a processor. When the communication apparatus is a module (for example, a chip) in a communication device, the transceiver unit may be an input/output interface, an input/output circuit, an input/output pin, or the like, and may also be referred to as an interface, a communication interface, an interface circuit, or the like; and the processing unit may be a processor, a processing circuit, a logic circuit, or the like.

In another possible design, the communication apparatus includes a processor, and may further include a transceiver. The transceiver is configured to send and receive a signal, and the processor executes program instructions, to complete the method according to any possible design or implementation of the first aspect. The communication apparatus may further include one or more memories. The memory is configured to be coupled to the processor, and the memory may store a computer program or instructions for implementing functions in any possible design or implementation of the first aspect. The processor may execute the computer program or the instructions stored in the memory. When the computer program or the instructions are executed, the communication apparatus is enabled to implement the method according to any possible design or implementation of the first aspect.

In another possible design, the communication apparatus includes a processor. The processor may be configured to be coupled to a memory. The memory may store a computer program or instructions for implementing functions in any possible design or implementation of the first aspect. The processor may execute the computer program or the instructions stored in the memory. When the computer program or the instructions are executed, the communication apparatus is enabled to implement the method according to any possible design or implementation of the first aspect.

In another possible design, the communication apparatus includes a processor and an interface circuit. The processor is configured to: communicate with another apparatus by using the interface circuit, and perform the method according to any possible design or implementation of the first aspect.

It may be understood that, in the second aspect, the processor may be implemented by using hardware or software. When the processor is implemented by using hardware, the processor may be a logic circuit, an integrated circuit, or the like. When the processor is implemented by using software, the processor may be a general-purpose processor, and is implemented by reading software code stored in the memory. In addition, there may be one or more processors, and one or more memories. The memory may be integrated with the processor, or the memory and the processor are disposed separately. In an example implementation process, the memory and the processor may be integrated into a same chip, or may be disposed on different chips. A type of the memory and a manner in which the memory and the processor are disposed are not limited in embodiments of this disclosure.

According to a third aspect, an embodiment of this disclosure provides a communication system. The communication system includes the terminal and the network device according to the first aspect.

According to a fourth aspect, this disclosure provides a chip system. The chip system includes a processor, and may further include a memory, configured to implement the method according to any possible design of the first aspect. The chip system may include a chip, or may include a chip and another discrete device.

According to a fifth aspect, this disclosure further provides a computer-readable storage medium. The computer-readable storage medium stores computer-readable instructions. When the computer-readable instructions are run on a computer, the computer is enabled to perform the method according to any possible design of the first aspect.

According to a sixth aspect, this disclosure provides a computer program product including instructions. When the computer program product runs on a computer, the computer is enabled to perform the method in various embodiments of the first aspect.

For technical effects that can be achieved in the second aspect to the sixth aspect, refer to descriptions of the technical effects that can be achieved in the corresponding possible design solutions in the first aspect. Details are not described herein again in this disclosure.

### BRIEF DESCRIPTION OF DRAWINGS

FIG. 1 is a diagram of a terrestrial communication system according to an embodiment of this disclosure;

FIG. 2 is a diagram of a non-terrestrial communication system according to an embodiment of this disclosure;

FIG. 3 is a diagram of an architecture of a 5G satellite communication system according to an embodiment of this disclosure;

FIG. 4 is a schematic flowchart of a communication method according to an embodiment of this disclosure;

FIG. 5 is a diagram of resource occupation of UE according to an embodiment of this disclosure;

FIG. 6 is a diagram of resource occupation of UE according to this disclosure;

FIG. 7 is a diagram of resource occupation of UE according to this disclosure;

FIG. 8 is a diagram of a structure of a communication apparatus according to an embodiment of this disclosure;

FIG. 9 is a diagram of a structure of another communication apparatus according to an embodiment of this disclosure; and

FIG. 10 is a diagram of a structure of still another communication apparatus according to an embodiment of this disclosure.

### DESCRIPTION OF EMBODIMENTS

To make the objectives, technical solutions, and advantages of this disclosure clearer, the following further describes this disclosure in detail with reference to the accompanying drawings. An example operation method in a method embodiment may also be applied to an apparatus embodiment or a system embodiment. In the descriptions of this disclosure, unless otherwise specified, a plurality of means two or more than two. Therefore, for implementations of the apparatus and the method, reference may be made to each other, and repeated parts are not described again.

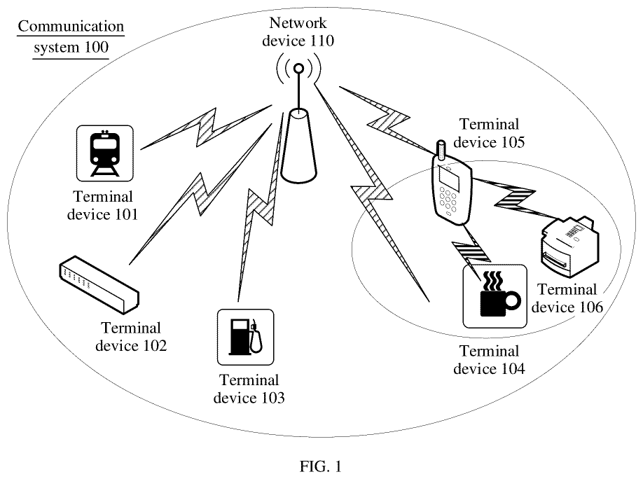

FIG. 1 shows an architecture of a terrestrial network communication system. The communication system 100 may include a network device 110 and terminal devices 101 to 106. It should be understood that the communication system 100 may include more or fewer network devices or terminal devices. The network device or the terminal device may be hardware, or may be software obtained through function division, or may be a combination thereof. In addition, the terminal devices 104 to 106 may also form a communication system. For example, the terminal device 105 may send downlink data to the terminal device 104 or the terminal device 106. The network device or the terminal device may communicate with each other by using another device or network element. The network device 110 may send downlink data to the terminal devices 101 to 106, or may receive uplink data sent by the terminal devices 101 to 106. Certainly, the terminal devices 101 to 106 may also send uplink data to the network device 110, or may receive downlink data sent by the network device 110.

The network device 110 is a node in a radio access network (RAN), and may also be referred to as a base station or a RAN node (or a device). Currently, some examples of an access network device are a next generation Node B (gNB), a transmitting point (TP), a transmission reception point (TRP), a home base station (for example, a home evolved NodeB or a home Node B, HNB), a macro base station, a micro base station (also referred to as a small cell), a relay station, or a baseband unit (BBU) in a 5G network; or a network device in a communication system evolved after 5G, for example, 6th generation (6G). The network device 110 may alternatively be another device having a network device function. For example, the network device 110 may alternatively be a device that undertakes a base station function in device-to-device (D2D), vehicle-to-everything (V2X), or machine-to-machine (M2M) communication; may include a central unit (CU) and a distributed unit (DU) in a cloud access network (C-RAN) system; or may be a network device in a non-terrestrial network (NTN) communication system, that is, may be deployed on a high-altitude platform or a satellite. This is not limited in embodiments of this disclosure.

The terminal devices 101 to 106 may also be referred to as UEs, mobile stations (MSs), mobile terminals (MTs), or the like, and are devices that provide voice or data connectivity for users; or may be internet-of-things devices. For example, the terminal devices 101 to 106 include a handheld device, a vehicle-mounted device, and the like that have a wireless connection function. Currently, the terminal devices 101 to 106 each may be a mobile phone, a tablet computer, a notebook computer, a palmtop computer, a customer-premises equipment (CPE), a mobile internet device (MID), a wearable device (for example, a smart watch, a smart band, or a pedometer), a vehicle-mounted device (for example, a vehicle-mounted device on an automobile, a bicycle, an electric vehicle, an aircraft, a ship, a train, or a high-speed train), a virtual reality (VR) device, an augmented reality (AR) device, a wireless terminal in industrial control, a smart home device (for example, a refrigerator, a television, an air conditioner, or an electricity meter), an intelligent robot, a workshop device, a wireless terminal in self-driving, a wireless terminal in remote medical surgery, a wireless terminal in a smart grid, a wireless terminal in transportation safety, a wireless terminal in a smart city, a wireless terminal in a smart home, a flight device (for example, an intelligent robot, a hot balloon, an uncrewed aerial machine, or an aircraft), or the like. The terminal devices 101 to 106 each may alternatively be another device having a terminal function. For example, the terminal devices 101 to 106 may alternatively be devices having a terminal function in D2D communication.

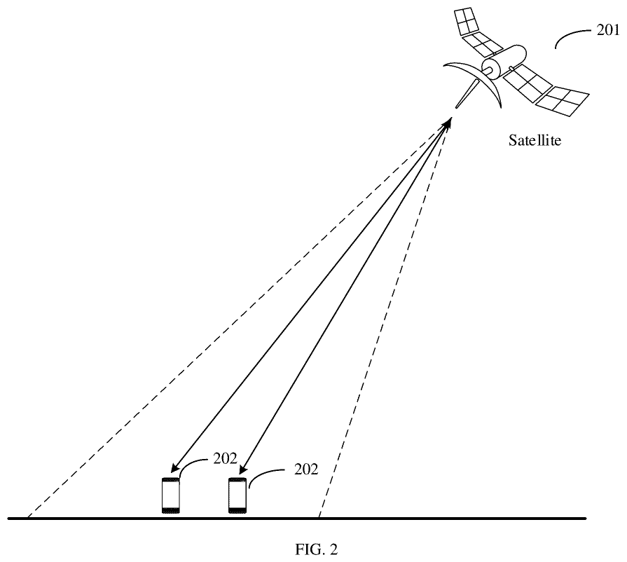

Based on the descriptions of the architecture of the terrestrial network communication system shown in FIG. 1, a communication method provided in embodiments of this disclosure is applicable to an NTN communication system. As shown in FIG. 2, the NTN communication system includes a satellite 201 and terminal devices 202. For explanation of the terminal device 202, refer to the related descriptions of the terminal devices 101 to 106. The satellite 201 may also be referred to as a high-altitude platform, a high-altitude aircraft, or a satellite base station. If the NTN communication system is compared with a terrestrial network communication system, the satellite 201 may be considered as one or more network devices in an architecture of the terrestrial network communication system. The satellite 201 provides a communication service for the terminal device 202, and the satellite 201 may be further connected to a core network device. For a structure and a function of the satellite 201, refer to the foregoing descriptions of the network device. For a communication manner between the satellite 201 and the terminal device 202, refer to the descriptions in FIG. 1. Details are not described herein again.

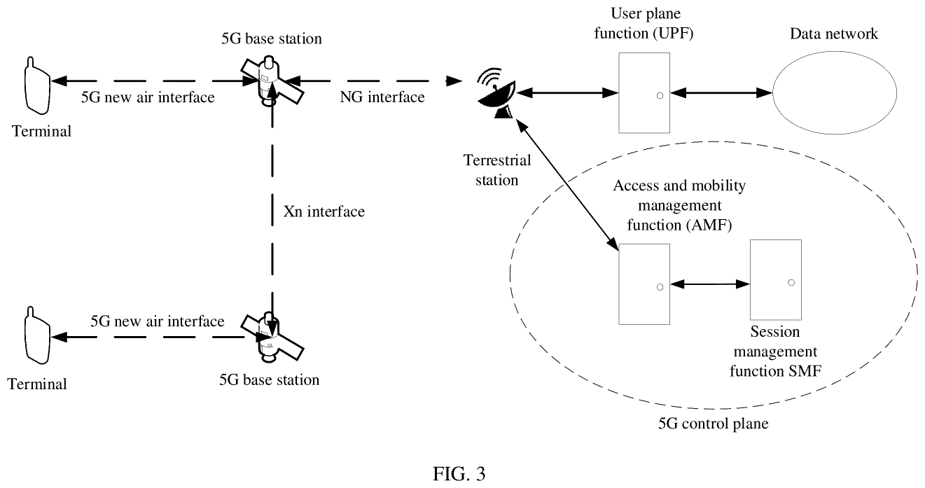

Using 5G as an example, an architecture of a 5G satellite communication system is shown in FIG. 3. A terrestrial terminal device accesses a network through 5G new radio. A 5G base station is deployed on a satellite, and is connected to a terrestrial core network through a radio link. In addition, there is a radio link between satellites, to complete signaling exchange and user data transmission between base stations. Devices and interfaces in FIG. 3 are described as follows.
5G core network: provides services such as user access control, mobility management, session management, user security authentication, and charging, includes a plurality of functional units, and may be divided into a control plane functional entity and a data plane functional entity. An access and mobility management unit (AMF) is responsible for user access management, security authentication, and mobility management. A user plane function (UPF) is responsible for functions such as managing user plane data transmission and traffic statistics. A session management function (SMF) is mainly used for session management in a mobile network, for example, session establishment, modification, and release.
Terrestrial station: is responsible for forwarding signaling and service data between a satellite base station and the 5G core network.
5G new radio: is a radio link between a terminal and a base station.
Xn interface: is an interface between 5G base stations, and is mainly used for signaling interaction, for example, a handover.
NG interface: is an interface between a 5G base station and the 5G core network, and mainly exchanges non-access stratum (NAS) signaling or other signaling of the core network, and service data of a user.

The network device in the terrestrial network communication system and the satellite in the NTN communication system may be collectively considered as network devices. An apparatus configured to implement a function of the network device may be a network device or may be an apparatus that can support the network device in implementing the function, for example, a chip system. The apparatus may be mounted in the network device. When the technical solutions provided in embodiments of this disclosure are described below, an example in which an apparatus configured to implement a function of a network device is a satellite is used to describe the technical solutions provided in embodiments of this disclosure. It may be understood that when the method provided in embodiments of this disclosure is applied to the terrestrial network communication system, an action performed by the satellite may be performed by a base station or a network device.

In embodiments of this disclosure, an apparatus configured to implement a function of the terminal device may be a terminal device, or may be an apparatus that can support the terminal device in implementing the function, for example, a chip system. The apparatus may be mounted in the terminal device. In embodiments of this disclosure, the chip system may include a chip, or may include a chip and another discrete device. In the technical solutions provided in embodiments of this disclosure, an example in which an apparatus configured to implement a function of the terminal device is a terminal or UE is used to describe the technical solutions provided in embodiments of this disclosure.

In addition, the satellite may be a geostationary satellite, a non-geostationary satellite, an artificial satellite, a low earth orbit satellite, a medium earth orbit satellite, a high earth orbit satellite, or the like. This is not limited herein in this disclosure.

When receiving configuration information of a reference signal from the network device, the terminal device needs to determine an occupied reference signal resource based on the configuration information of a reference signal. A 5G NR standard defines two reference signals DMRS and CSI-RS used for channel state measurement. Configuration information of the two types of reference signals is UE dedicated information, and the network device indicates the configuration information to the UE by using RRC signaling.

A downlink (DL) DMRS is used as an example. NR supports only a UE-dedicated DMRS for DL channel estimation. Because NR uses a codebook-based design, the DMRS and data are precoded by using a same codebook, and the UE only needs to estimate an equivalent channel, and can demodulate data without learning a DL precoding codebook used by a base station. The NR standard supports a maximum of 12 DL orthogonal DMRS ports. For single-user multiple-input multiple-output (SU-MIMO), each UE supports a maximum of eight DL orthogonal DMRS ports. For multiple-user multiple-input multiple-output (MU-MIMO), each UE supports a maximum of four DL orthogonal DMRS ports.

However, in the NTN, a service is performed based on a beam, transmission environments of users in the beam are similar, each beam uses a precoding codebook, and user codebooks are not distinguished in a single beam. In addition, a user in the beam preferably transmits only one data stream, and there is no requirement of using a plurality of DL orthogonal DMRS ports in the beam. Therefore, the DL DMRS may be used as beam common information for indication. The CSI-RS may also be used as beam common information for indication in an NTN scenario.

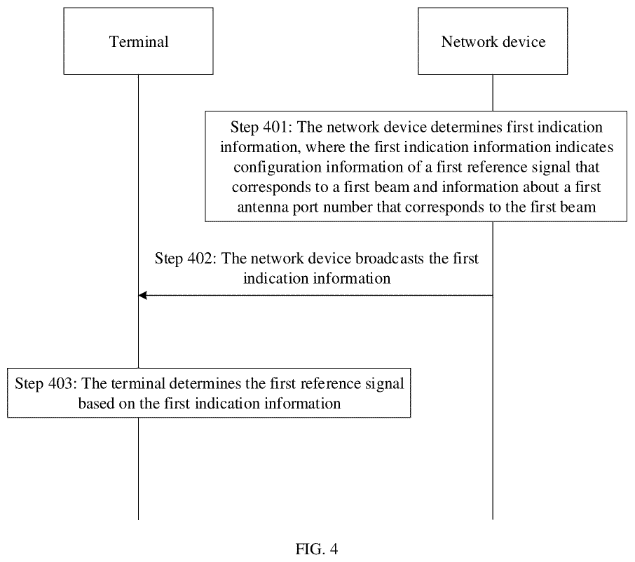

Based on this, to avoid indicating configuration information of a reference signal for each UE by using RRC signaling, this disclosure provides a beam-level method for indicating configuration information of a reference signal, to reduce reference signal indication overheads. With reference to FIG. 4, execution may be performed through interaction between a terminal and a network device. The terminal may be understood as the terminal itself, or may be understood as a chip disposed inside the terminal. This is not limited herein. The terminal may be a mobile phone, a vehicle-mounted device, an internet of things device, or the like. The network device may be understood as the network device itself, or may be understood as a chip disposed inside the network device. The network device may be a base station, a satellite, an access point, or the like. The method may be applied to a 5G communication system or a communication system above 5G, or may be applied to a non-terrestrial communication system. This is not limited in this disclosure. During actual applications, execution is as follows.
Step 401: The network device determines first indication information, where the first indication information indicates configuration information of a first reference signal that corresponds to a first beam and information about a first antenna port number that corresponds to the first beam.

In one embodiment, the first beam may provide a communication service for a plurality of terminals, for example, provide a communication service for a terminal located in an area 1. The terminal in the area 1 may include a mobile phone, a smartwatch, a notebook computer, or the like. This is merely an example for description herein. Reference signals used by the plurality of terminals served by the first beam are usually have same configuration information and antenna port number information. Based on this, the network device may determine the first indication information.

The first reference signal may be a DMRS, a CSI-RS, or a PTRS, and in future communication, may be another reference information used for channel estimation. This is not limited in this disclosure. In addition, the foregoing reference signals usually one-to-one correspond to antenna port numbers. For example, the reference signals are DMRSs, and antenna port numbers of a DMRS configuration type 1 may be 1000, 1001, 1002, 1003, 1004, 1005, 1006, and 1007, where the ports 1000, 1001, 1004, and 1005 belong to a same CDM group. Herein, DMRS_1000 represents a DMRS whose port number is 1000. The configuration information of the first reference signal includes time-frequency density, a scrambling manner, and the like of the first reference signal. This is not limited in this disclosure.

When the first reference signal is the DMRS, the configuration information may be shown below:

| | |
|---|---|
| DMRS-DownlinkConfig ::= | SEQUENCE { |
| dmrs-Type | ENUMERATED {type2} |
| dmrs-AdditionalPosition | ENUMERATED {pos0, pos1, pos3} |
| maxLength | ENUMERATED {len2} |
| scramblingID0 | INTEGER (0..65535) |
| scramblingID1 | INTEGER (0..65535) |
| phaseTrackingRS | SetupRelease { PTRS- |
| | DownlinkConfig } |
| ..., | |
| } | |

dmrs-Type represents a DMRS type; dmrs-AdditionalPosition represents an additional DMRS position; maxLength represents a quantity of OFDM symbols occupied by a front loaded DMRS; scramblingID0 and scramblingID1 represent DMRS scrambling manners; and phaseTrackingRS represents a PTRS configuration.

In addition, if positions of UEs in the first beam are different, different reference signal configurations are required, for example, time-frequency density of the DMRS and time-frequency density of the CSI-RS. For example, if the UE is located at a position that is in a beam and that is close to a satellite, a link budget is good, and a single-symbol pilot may be configured. If the UE is located at a position that is in a beam and that is far from a satellite, a link budget is poor, and a dual-symbol pilot may be configured. Therefore, the first indication information may further indicate configuration information of a second reference signal that corresponds to the first beam and information about a second antenna port number that corresponds to the first beam, that is, indicate configuration information of a plurality of groups of reference signals in a beam-level broadcast signal (the plurality of groups of reference signals may be of a same type, or may be of different types, and different reference signals have different purposes, which is not limited herein in this disclosure), and indicate a configuration index of a reference signal in UE-level RRC signaling or DCI. For example, reference signals corresponding to the first beam include a DMRS1, a DMRS2, and a CSI-RS1, and terminals served by the first beam include terminals 1 to 100. For example, configuration information of the DMRS1, the DMRS2, and the CSI-RS1 and information about an antenna port number corresponding to each reference signal are indicated in the first indication information. An index 1 is indicated in RRC signaling of UEs 1 to 50. The index 1 corresponds to the configuration information of the DMRS1, that is, the UEs 1 to 50 are indicated to determine a reference signal by using the configuration information of the DMRS1. An index 2 is indicated in RRC signaling of UEs 51 to 100. The index 2 corresponds to the configuration information of the DMRS2, that is, the UE 51 to the UE 100 are indicated to determine a reference signal by using the configuration information of the DMRS2. An index 3 is indicated in RRC signaling of UEs 1 to 100. The index 3 corresponds to the configuration information of the CSI-RS1, that is, the UE 1 to the UE 100 are indicated to alternatively determine a reference signal by using the configuration information of the CSI-RS1. If one beam corresponds to N types of configuration information and antenna port numbers of a reference signal, for example, N=2, in one beam, a part of terminals use a first type of configuration information and information about an antenna port number of a reference signal, and other terminals use a second type of configuration information and information about an antenna port number of a reference signal. In this way, configurations of two types of reference signals may be simultaneously broadcast in a broadcast signal. In terminal-level signaling (such as RRC signaling or DCI), only one bit indicates an index of a reference signal configuration, to reduce terminal-level signaling indication overheads.
Step 402: The network device broadcasts the first indication information. Correspondingly, the terminal may receive the first indication information.

The network device may perform indication by using signaling such as a SIB, DCI (the DCI may be used to schedule a SIB), or a master information block (MIB). Certainly, during actual application, other signaling indication used for broadcasting may also be used. This is not limited herein. In one embodiment, a field may be added to a SIB1 to indicate the information indicated by the first indication information, or a reserved field of the SIB may be used for indication. This is not limited herein. Compared with a case in which configuration information of a reference signal is directly indicated to terminals one by one by using RRC signaling, indicating the first indication information by using the foregoing signaling can reduce indication overheads.

For example, a field is added to the SIB1 to indicate beam-level DMRS configuration information Beam-DMRS-DownlinkConfig and a beam-level antenna port number Beam-Antenna-Port. If the beam-level DMRS configuration and the beam-level antenna port number do not need to be changed in an update period of the SIB1, the DMRS configuration and the antenna port number are no longer indicated in the UE-level RRC signaling and DCI. If the beam-level DMRS configuration and the beam-level antenna port number need to be changed in the update period of the SIB1, an updated DMRS configuration and an updated antenna port number are indicated in the UE-level RRC signaling and DCI, and a reference signal is determined based on information indicated in the UE-level RRC signaling and DCI. In addition, a field may be further added to DCI for scheduling the SIB1 to indicate a beam-level antenna port. Example descriptions are merely provided herein, and no specific limitation is imposed.

In addition, in an existing NR standard, a broadcast update period (that is, a broadcast message update period) is defined as SFN mod m=0. SFN represents a radio frame number, and m=modificationPeriodCoeff (an update period coefficient)*defaultPagingCycle (a default paging cycle) represents an update period. That is, a broadcast message may be updated only in a radio frame that satisfies the foregoing formula. modificationPeriodCoeff and defaultPagingCycle are parameters in a SIB2. For example, if modificationPeriodCoeff is 2 and defaultPagingCycle is 32 rf, the update period is 64 rf. rf represents a quantity of radio frames.

In an existing standard, a minimum update period of the broadcast message is 64 radio frames (640 ms). If the DMRS configuration information needs to be updated within 640 ms, the broadcast message cannot be used for update indication, and beam scheduling is limited. Therefore, in this disclosure, an update period of a beam-level broadcast message is redefined, and the update period of the beam-level broadcast message may be set to 1/N of the broadcast update period. A value of N is 2^{L}, and L is a positive integer. This manner can increase a signaling update frequency, and improve flexibility of a reference information configuration. In one embodiment, the following manners may be used.
Manner 1: A beam-level update period of the signaling is determined by using Formula 1:

$$m = M * D / N \qquad Formula 1$$

m represents an update period, m is in a unit of a quantity of radio frames rf, M represents a beam-level update period coefficient (that is, modificationPeriodCoeff), a value of M is 2^{X1}, X1 is an integer greater than 1, D represents a beam-level paging cycle (that is, defaultPagingCycle), and a value of D is 32 rf.
Manner 2: A beam-level update period of the signaling is determined by using Formula 2:

$$m = M * D \qquad Formula 2$$

M represents a beam-level update period coefficient, a value of M is 1 or ½L, D represents a beam-level paging cycle, and a value of D is 32 rf.
Manner 3: A beam-level update period of the signaling is determined by using Formula 2. However, a value of M is 2^{X1}, X1 is an integer greater than 1, and a value of D is at least one of the following: 1 rf, 2 rf, 4 rf, 8 rf, or 16 rf.

In the foregoing manners, an update period of signaling may be reduced to a minimum of one radio frame, that is, the beam-level broadcast message may be updated once every 10 ms, to improve flexibility of updating the reference signal configuration.

In addition, during actual application, a configuration parameter of the beam-level update period may be added to the broadcast signal. For example, the configuration parameter of the beam-level update period of the signaling is indicated through fourth indication information. When receiving the beam-level update period, the terminal may use the parameter to calculate the beam-level broadcast update period.
Step 403: The terminal determines the first reference signal based on the first indication information.

In one embodiment, the terminal may directly determine a subsequence of the first reference signal based on the first indication information by referring to an existing protocol rule, or based on a preset configuration rule of a subsequence of a reference signal. This is not limited in this disclosure.

When a plurality of beams of a plurality of orthogonal ports are used for simultaneous transmission, orthogonality of DMRSs between the beams of the plurality of orthogonal ports needs to be ensured. In the NR standard, DL DMRS mapping starts from a subcarrier 0 of a resource block (RB) 0 in a bandwidth allocated to the UE, even if two beams have a same carrier bandwidth (the same carrier bandwidth means that starting positions, end positions, and lengths of carrier bandwidths of the two beams are the same), that is, have a same point A, where the point A is a common reference point of a resource block grid. Usually, a center point of a subcarrier 0 of a common resource block (CRB) 0 in all subcarrier spacings is referred to as the point A, and may be understood as a position of a lowest RB in a full bandwidth. The point A is obtained through calculation based on k_SSB and OffsetToPointA. k_SSB represents an offset between a subcarrier 0 of an SSB and a subcarrier 0 of a CRB in which the SSB is located, and is determined by information carried in the MIB. OffsetToPointA represents an offset between the subcarrier 0 of the CRB in which the SSB is located and the subcarrier 0 of the CRBO, and is indicated by a higher-layer parameter ssb-SubcarrierOffset. In addition, the point A may be used to calculate a starting position of a BWP by Formula 3:

$${N}_{BWP}^{start} = {O}_{carrier} + {RB}_{start} \qquad Formula 3$$

O_{carrier} represents an offset from

$${N}_{grid}^{start , μ}$$

to the point A, and is indicated by a parameter offsetToCarrier. RBₛₜₐᵣₜ represents an offset between the BWP and

$${N}_{grid}^{start , μ} ,$$

and is determined by a parameter locationAndBandwidth. The parameter locationAndBandwidth can also determine a quantity of consecutive PRBs in the BWP. For understanding of the parameters, refer to an existing protocol. Details are not described herein again.

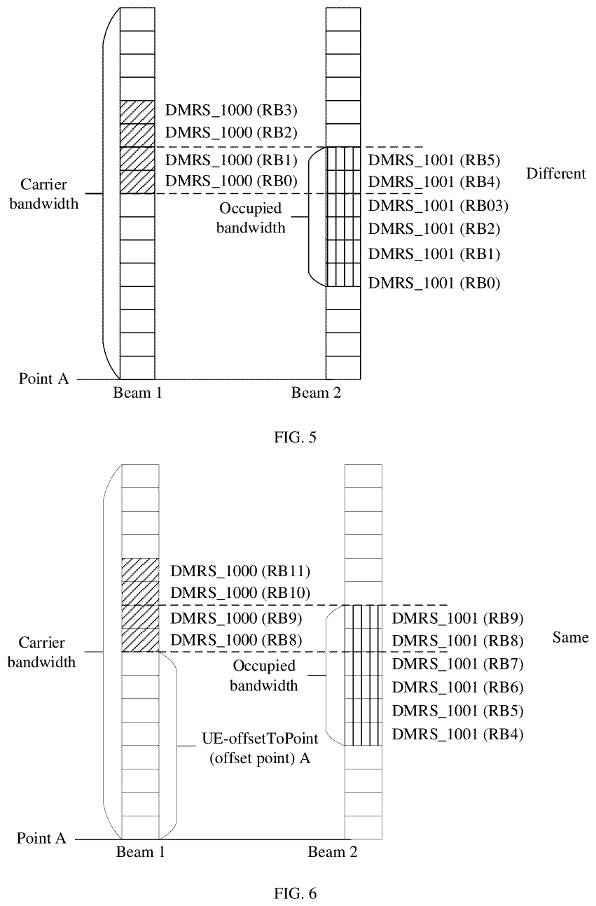

However, when actual serving bandwidths of the two beams are different and orthogonal beam-level DMRS ports are used between the beams, DMRS sequences may not be orthogonal in an overlapping part. As shown in FIG. 5, an example in which each beam 1 and each beam 2 separately serve one user is used. When orthogonal DMRS ports (for example, a port 1000 and a port 1001) belong to a same CDM group, sequences are “misaligned” due to different actually occupied bandwidths. As a result, sequence numbers of overlapping parts of two DMRS sequences of the orthogonal DMRS ports are different in the DMRS sequences. That is, in FIG. 5, sequences in an overlapping part of a bandwidth occupied by the user corresponding to the beam 1 and a bandwidth occupied by the user corresponding to the beam 2 are different. Sequences in the overlapping part of the beam 1 are DMRS_1000 (RB0) and DMRS_1000 (RB1), and sequences in the overlapping part of the beam 2 are DMRS_1001 (RB4) and DMRS_1001 (RB5). DMRS_1000 (RB0) represents a subsequence of a DMRS sequence whose port is 1000 on the RB0; DMRS_1000 (RB1) represents a subsequence of a DMRS sequence whose port is 1000 on the RB1; DMRS_1001 (RB4) represents a subsequence of a DMRS sequence whose port is 1001 on the RB4; and DMRS_1001 (RB5) represents a subsequence of a DMRS sequence whose port is 1001 on the RB5.

Based on this, the terminal may determine the subsequence of the first reference signal based on the preset configuration rule of a subsequence of a reference signal, to ensure that a subsequence of a reference signal in a beam adjacent to the first beam is the same as the subsequence of the first reference signal in an overlapping part.

The following uses the beam adjacent to the first beam and a second beam as an example for description. Two different cases below are included. Details are as follows.

Case 1: The First Beam and the Second Beam have a Same Carrier Bandwidth (or a Starting Position of a BWP of the First Beam and a Starting Position of a BWP of the Second Beam are the Same).
Rule 1: The terminal determines, based on a resource offset between a resource allocated to the terminal and a reference resource, a subsequence that is of the first reference signal and that is occupied by the terminal, where the reference resource is a common reference point of a resource block grid or a starting position of a bandwidth part BWP. In other words, after receiving the first indication information, the terminal may determine to reorder the subsequence of the first reference signal directly based on the resource offset between a reference resource and a resource allocated, to ensure that a subsequence of a reference signal allocated to the terminal with a port orthogonal to a first antenna port is orthogonal to the subsequence of the first reference signal in an overlapping part.
Rule 2: The network device further broadcasts second indication information, where the second indication information indicates the terminal to determine a sequence of a reference signal based on a reference resource offset, and the reference resource is a common reference point of a resource block grid or a starting position of a BWP; and the terminal receives the second indication information from the network device, and determines, based on a resource offset between a resource allocated to the terminal and a reference resource, a subsequence that is of the first reference signal and that is occupied by the terminal. In other words, after receiving the second indication information, the terminal determines to reorder the subsequence of the first reference signal based on the resource offset between the reference resource and the resource allocated.

During actual application, whether Rule 1 or Rule 2 is used may be preconfigured between the network device and the terminal. This is not limited in this disclosure. A main difference between the two rules lies in different execution occasions. In one of the rules, the second indication information is not required, and the first reference signal subsequence may be reordered directly based on the resource offset between a reference resource and a resource allocated. In another rule, the second indication information needs to be received, and then the subsequence of the first reference signal is reordered based on the resource offset between a reference resource and a resource allocated. This is not limited in this disclosure. Using which of the rules can be flexibly set based on an actual requirement.

The following uses FIG. 6 as an example to describe how to reorder the subsequence of the first reference signal based on the resource offset between a reference resource and a resource allocated (FIG. 6 is an improvement of FIG. 5). In FIG. 6, the beam 1 and the beam 2 have a same carrier bandwidth, the reference resource is the point A. In the beam 1, if a resource offset UE-offsetToPointA between the point A and a resource occupied by the terminal is eight RBs, resources DMRS_1000 (RB0) to DMRS_1000 (RB3) occupied by the terminal in FIG. 5 are reordered as DMRS_1000 (RB8) to DMRS_1000 (RB11). In the beam 2, if the resource offset UE-offsetToPointA between the point A and a resource occupied by the terminal is four RBs, resources DMRS_1001 (RB0) to DMRS_1001 (RB5) occupied by the terminal in FIG. 5 are reordered as DMRS_1001 (RB4) to DMRS_1001 (RB9). Therefore, sequences in an overlapping part of a bandwidth occupied by the user corresponding to the beam 1 and a bandwidth occupied by the user corresponding to the beam 2 are the same. This can ensure that the DMRS sequence is orthogonal in the overlapping part.

Case 2: The First Beam and the Second Beam have Different Carrier Bandwidths (or a Starting Position of a BWP of the First Beam and a Starting Position of a BWP of the Second Beam are Different).

The network device determines a resource offset, where the resource offset indicates a resource offset between a common reference point of a resource block grid of the first beam and a common reference point of a resource block grid of the second beam, or a resource offset between a starting position of a BWP of the first beam and a starting position of a BWP of the second beam. The network device broadcasts third indication information, where the third indication information indicates the resource offset. The terminal receives the third indication information from the network device, and determines, based on the third indication information and a resource allocated to the terminal, a subsequence that is of the first reference signal and that is occupied by the terminal. After receiving the third indication information indicating the resource offset, the terminal determines to reorder the subsequence of the first reference signal based on the resource offset and the resource allocated to the terminal, to ensure that a subsequence of a reference signal allocated to the terminal with a port orthogonal to a first antenna port is orthogonal to the subsequence of the first reference signal in an overlapping part.

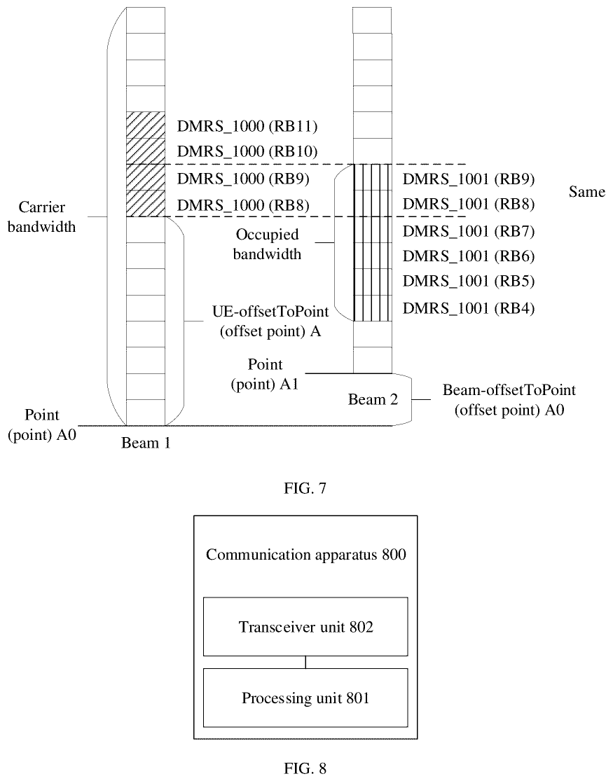

In one embodiment, with reference to FIG. 7, it may be understood that the beam 1 and the beam 2 have different carrier bandwidths, and an example in which each beam 1 and each beam 2 separately serve one user is used. When orthogonal DMRS ports (for example, a port 1000 and a port 1001) belong to a same CDM group, a common reference point of a resource block grid of the beam 1 is the point A, and a common reference point of a resource block grid of the beam 2 is a point A0. An offset between the point A and the point A0 is the resource offset. If the point A is used as a reference, the resource offset may be a value obtained by point A0-point A. If the point A0 is used as the reference, the resource offset may be a value obtained by point A-point A0. This is not limited in this disclosure. During actual indication, if an indication field of the resource offset is Beam-offsetToPointA0, it may be determined that the point A0 is used as the reference for calculating the resource offset. In FIG. 6, Beam-offsetToPointA0 is two RBs. In the beam 1, if the resource offset UE-offsetToPointA between the point A0 and a resource occupied by the terminal is eight RBs, resources are reordered as DMRS_1000 (RB8) to DMRS_1000 (RB11). In the beam 2, if the resource offset UE-offsetToPointA between the point A and a resource occupied by the terminal is two RBs, and the resource offset UE-offsetToPointA between the point A0 and a resource occupied by the terminal is four RBs, resources are reordered as DMRS_1001 (RB4) to DMRS_1001 (RB9). In this case, subsequences in an overlapping part of a bandwidth occupied by the user corresponding to the beam 1 and a bandwidth occupied by the user corresponding to the beam 2 are the same.

In this disclosure, the network device indicates the first indication information to the terminal device through broadcast. The first indication information is beam-level indication information, and is not separately indicated for each terminal. In this manner, configuration information of a reference signal does not need to be configured in RRC signaling for each terminal, and therefore reference signal indication overheads can be reduced.

In addition, it should be further noted that the first indication information, the second indication information, the third indication information, and the fourth indication information in this disclosure may all be carried by using a SIB and DCI used for scheduling a SIB. This is not limited in this disclosure.

The foregoing mainly describes the solutions provided in embodiments of this disclosure from a perspective of device interaction. It may be understood that to implement the foregoing functions, each device may include a corresponding hardware structure and/or software module for performing each function. A person skilled in the art should be easily aware that in combination with units and algorithm steps of the examples described in embodiments disclosed in this specification, embodiments of this disclosure may be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this disclosure.

In embodiments of this disclosure, the device may be divided into functional units based on the foregoing method examples. For example, each functional unit may be obtained through division based on each corresponding function, or two or more functions may be integrated into one unit. The integrated unit may be implemented in a form of hardware, or may be implemented in a form of a software functional unit.

When an integrated unit is used, FIG. 8 is a possible example block diagram of a communication apparatus according to an embodiment of this disclosure. As shown in FIG. 8, the communication apparatus 800 may include a processing unit 801 and a transceiver unit 802. The processing unit 801 is configured to control and manage an action of the communication apparatus 800. The transceiver unit 802 is configured to support communication between the communication apparatus 800 and another device. Optionally, the transceiver unit 802 may include a receiving unit and/or a sending unit, which are respectively configured to perform a receiving operation and a sending operation. Optionally, the communication apparatus 800 may further include a storage unit, configured to store program code and/or data of the communication apparatus 800. The transceiver unit may be referred to as an input/output unit, a communication unit, or the like, and the transceiver unit may be a transceiver. The processing unit may be a processor. When the communication apparatus is a module (for example, a chip) in a communication device, the transceiver unit may be an input/output interface, an input/output circuit, an input/output pin, or the like, and may also be referred to as an interface, a communication interface, an interface circuit, or the like; and the processing unit may be a processor, a processing circuit, a logic circuit, or the like. In one embodiment, the apparatus may be the foregoing terminal, network device, or the like.

In an embodiment, the transceiver unit 802 is configured to receive first indication information broadcast by a network device, where the first indication information indicates configuration information of a first reference signal that corresponds to a first beam and information about a first antenna port number that corresponds to the first beam. The processing unit 801 is configured to determine the first reference signal based on the first indication information.

Optionally, the processing unit 801 is configured to determine, based on a resource offset between a resource allocated to the terminal and a reference resource, a subsequence that is of the first reference signal and that is occupied by the terminal, where the reference resource is a common reference point of a resource block grid or a starting position of a bandwidth part BWP.

Optionally, the transceiver unit 802 is further configured to receive second indication information broadcast by the network device, where the second indication information indicates the terminal to determine a sequence of a reference signal based on a reference resource offset, and the reference resource is a common reference point of a resource block grid or a starting position of a BWP. The processing unit 801 is further configured to determine, based on a resource offset between a resource allocated to the terminal and a reference resource, a subsequence that is of the first reference signal and that is occupied by the terminal.

Optionally, the transceiver unit 802 is further configured to receive third indication information broadcast by the network device, where the third indication information indicates a resource offset between the first beam and a second beam, the resource offset indicates a resource offset between a common reference point of a resource block grid of the first beam and a common reference point of a resource block grid of the second beam, or a resource offset between a starting position of a BWP of the first beam and a starting position of a BWP of the second beam, and the first beam and the second beam have different carrier bandwidths, or the first beam and the second beam have different BWPs. The processing unit 801 is further configured to determine, based on the third indication information and a resource allocated to the terminal, a subsequence that is of the first reference signal and that is occupied by the terminal.

Optionally, the first indication information is carried by using the following signaling: a SIB or DCI.

Optionally, the transceiver unit 802 is further configured to receive fourth indication information broadcast by the network device, where the fourth indication information indicates a configuration parameter of a beam-level update period of the signaling.

Optionally, the beam-level update period of the signaling is determined by using the following formula:

$$m = M * D / N$$

m represents an update period, m is in a unit of a quantity of radio frames rf, M represents a beam-level update period coefficient, a value of M is 2^{X1}, X1 is an integer greater than 1, D represents a beam-level paging cycle, a value of D is 32 rf, a value of N is 2^{L}, and L is a positive integer.

Optionally, the beam-level update period of the signaling is determined by using the following formula:

$$m = M * D$$

m represents an update period, m is in a unit of a quantity of radio frames, M represents a beam-level update period coefficient, a value of M is 1 or ½^{L}, D represents a beam-level paging cycle, and a value of D is 32 rf. Alternatively, a value of M is 2^{X1}, X1 is an integer greater than 1, D represents a beam-level paging cycle, and a value of D is at least one of the following: 1 rf, 2 rf, 4 rf, 8 rf, or 16 rf.

Optionally, the first reference signal is a DMRS, a CSI-RS, or a PTRS.

Optionally, the first indication information further indicates configuration information of a second reference signal that corresponds to the first beam and information about a second antenna port number that corresponds to the first beam.

In still another embodiment, the processing unit 801 is configured to determine first indication information, where the first indication information indicates configuration information of a first reference signal that corresponds to a first beam and information about a first antenna port number that corresponds to the first beam. The transceiver unit 802 is configured to broadcast the first indication information.

Optionally, the transceiver unit 802 is further configured to broadcast second indication information, where the second indication information indicates the terminal to determine a sequence of a reference signal based on a reference resource offset, and the reference resource is a common reference point of a resource block grid or a starting position of a BWP.

Optionally, the processing unit 801 is further configured to determine a resource offset, where the resource offset indicates a resource offset between a common reference point of a resource block grid of the first beam and a common reference point of a resource block grid of the second beam, or a resource offset between a starting position of a BWP of the first beam and a starting position of a BWP of the second beam, and the first beam and the second beam have different carrier bandwidths, or the first beam and the second beam have different BWPs. The transceiver unit 802 is further configured to broadcast third indication information, where the third indication information indicates the resource offset.

Optionally, the first indication information is carried by using the following signaling:
a SIB or DCI.

Optionally, the transceiver unit 802 is further configured to broadcast fourth indication information, where the fourth indication information indicates a configuration parameter of a beam-level update period of the signaling.

Optionally, the beam-level update period of the signaling is determined by using the following formula:

$$m = M * D / N$$

m represents an update period, m is in a unit of a quantity of radio frames rf, M represents a beam-level update period coefficient, a value of M is 2^{X1}, X1 is an integer greater than 1, D represents a beam-level paging cycle, a value of D is 32 rf, a value of N is 2^{L}, and L is a positive integer.

Optionally, the beam-level update period of the signaling is determined by using the following formula:

$$m = M * D$$

m represents an update period, m is in a unit of a quantity of radio frames, M represents a beam-level update period coefficient, a value of M is 1 or ½^{L}, D represents a beam-level paging cycle, and a value of D is 32 rf. Alternatively, a value of M is 2^{X1}, X1 is an integer greater than 1, D represents a beam-level paging cycle, and a value of D is at least one of the following: 1 rf, 2 rf, 4 rf, 8 rf, or 16 rf.

Optionally, the first reference signal is a DMRS, a CSI-RS, or a PTRS.

Optionally, the first indication information further indicates configuration information of a second reference signal that corresponds to the first beam and information about a second antenna port number that corresponds to the first beam.

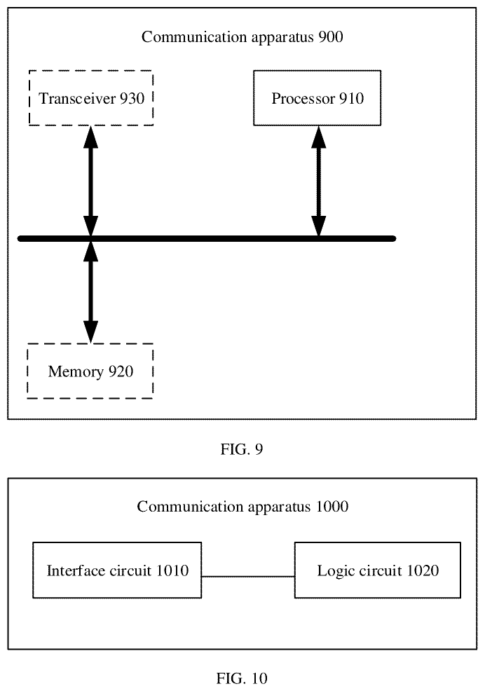

FIG. 9 shows a communication apparatus 900 further provided in this disclosure. The communication apparatus 900 may be a chip or a chip system. The communication apparatus may be located in the device in any one of the foregoing method embodiments, for example, a first satellite, a network device, or a terrestrial device, to perform an action corresponding to the device.

Optionally, the chip system may include a chip, or may include a chip and another discrete device.

The communication apparatus 900 includes a processor 910.

The processor 910 is configured to execute a computer program stored in a memory 920, to implement an action of each device in any one of the foregoing method embodiments.

The communication apparatus 900 may further include the memory 920, configured to store the computer program.

Optionally, the memory 920 is coupled to the processor 910. The coupling is an indirect coupling or a communication connection between apparatuses, units, or modules, may be in an electrical form, a mechanical from, or another form, and is for information exchange between the apparatuses, the units, or the modules. Optionally, the memory 920 and the processor 910 are integrated together.

There may be one or more processors 910 and one or more memories 920. This is not limited.

Optionally, during actual application, the communication apparatus 900 may include a transceiver 930 or may not include the transceiver 930. A dashed box is used as an example in the figure. The communication apparatus 900 may exchange information with another device through the transceiver 930. The transceiver 930 may be a circuit, a bus, or any other apparatus that may be configured to exchange information.

In a possible implementation, the communication apparatus 900 may be a first satellite or a terrestrial device in the foregoing method embodiments.

In this embodiment of this disclosure, a connection medium between the transceiver 930, the processor 910, and the memory 920 is not limited. In this embodiment of this disclosure, the memory 920, the processor 910, and the transceiver 930 are connected through a bus in FIG. 9. The bus is represented by using a thick line in FIG. 9. A manner of a connection between other components is merely an example for description, and is not limited thereto. The bus may be classified into an address bus, a data bus, a control bus, and the like. For ease of representation, only one thick line is used to represent the bus in FIG. 9, but this does not mean that there is only one bus or only one type of bus. In embodiments of this disclosure, the processor may be a general-purpose processor, a digital signal processor, an application-specific integrated circuit, a field programmable gate array or another programmable logic device, a discrete gate or a transistor logic device, or a discrete hardware component, and may implement or perform the methods, steps, and logical block diagrams disclosed in embodiments of this disclosure. The general-purpose processor may be a microprocessor or any conventional processor or the like. The steps of the method disclosed with reference to embodiments of this disclosure may be directly performed by a hardware processor, or may be performed by using a combination of hardware in the processor and a software module.

In embodiments of this disclosure, the memory may be a nonvolatile memory, for example, a hard disk drive (HDD) or a solid-state drive (SSD), or may be a volatile memory, for example, a random access memory (RAM). The memory may alternatively be any other medium that can be used to carry or store expected program code in a form of an instruction or a data structure and that can be accessed by a computer, but is not limited thereto. The memory in embodiments of this disclosure may alternatively be a circuit or any other apparatus that can implement a storage function, and is configured to store a computer program, program instructions, and/or data.

Based on the foregoing embodiments, refer to FIG. 10. An embodiment of this disclosure further provides another communication apparatus 1000, including an interface circuit 1010 and a logic circuit 1020. The interface circuit 1010 may be understood as an input/output interface, and may be configured to perform sending and receiving steps of each device in any one of the foregoing method embodiments. The logic circuit 1020 may be configured to run code or instructions to perform the method performed by each device in any one of the foregoing embodiments. Details are not described again.

Based on the foregoing embodiments, an embodiment of this disclosure further provides a computer-readable storage medium. The computer-readable storage medium stores instructions. When the instructions are executed, the method performed by each device in any one of the foregoing method embodiments is implemented. The computer-readable storage medium may include any medium that can store program code, for example, a USB flash drive, a removable hard disk, a read-only memory, a random access memory, a magnetic disk, or an optical disc.

Based on the foregoing embodiments, an embodiment of this disclosure provides a communication system. The communication system includes a first satellite, a terrestrial device, and another satellite mentioned in any one of the foregoing method embodiments, and may be configured to perform the method performed by each device in any one of the foregoing method embodiments.

A person skilled in the art should understand that embodiments of this disclosure may be provided as a method, a system, or a computer program product. Therefore, this disclosure may use a form of a hardware-only embodiment, a software-only embodiment, or an embodiment with a combination of software and hardware. In addition, this disclosure may use a form of a computer program product that is implemented on one or more computer-usable storage media (including but not limited to a magnetic disk memory, a compact disc read-only memory (CD-ROM), an optical memory, and the like) that include computer-usable program code.

This disclosure is described with reference to the flowcharts and/or block diagrams of the method, the apparatus (system), and the computer program product according to this disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of another programmable data processing apparatus to generate a machine, so that the instructions executed by a computer or the processor of any other programmable data processing apparatus generate an apparatus for implementing a function in one or more procedures in the flowcharts and/or in one or more blocks in the block diagrams.

These computer program instructions may alternatively be stored in a computer-readable memory that can indicate the computer or another programmable data processing apparatus to work in a designated manner, so that the instructions stored in the computer-readable memory generate an artifact that includes an instruction apparatus. The instruction apparatus implements a function in one or more procedures in the flowcharts and/or in one or more blocks in the block diagrams.

These computer program instructions may alternatively be loaded onto a computer or another programmable data processing apparatus, so that a series of operations and steps are performed on the computer or the another programmable apparatus to generate computer-implemented processing. Therefore, the instructions executed on the computer or the another programmable apparatus provide steps for implementing a function specified in one or more procedures in the flowcharts and/or in one or more blocks in the block diagrams.

What is claimed is:

1. A communication method performed by a communication apparatus, comprising:
receiving first indication information broadcast by a network device, wherein the first indication information indicates configuration information of a first reference signal that corresponds to a first beam and information about a first antenna port number that corresponds to the first beam; and
determining the first reference signal based on the first indication information.

2. The communication method according to claim 1, wherein determining the first reference signal based on the first indication information comprises:
determining based on a resource offset between a resource allocated to the communication apparatus and a reference resource, a subsequence that is of the first reference signal and that is occupied by the communication apparatus, wherein the reference resource is a common reference point of a resource block grid or a starting position of a bandwidth part (BWP).

3. The communication method according to claim 1, further comprising:
receiving second indication information broadcast by the network device, wherein the second indication information indicates the communication apparatus to determine a sequence of a reference signal based on a reference resource offset, and the reference resource is a common reference point of a resource block grid or a starting position of a bandwidth part (BWP); and
determining based on a resource offset between a resource allocated to the communication apparatus and a reference resource, a subsequence that is of the first reference signal and that is occupied by the communication apparatus.

4. The communication method according to claim 1, further comprising:
receiving third indication information broadcast by the network device, wherein the third indication information indicates a resource offset between the first beam and a second beam, the resource offset indicates a resource offset between a common reference point of a resource block grid of the first beam and a common reference point of a resource block grid of the second beam, or a resource offset between a starting position of a bandwidth part (BWP) of the first beam and a starting position of a BWP of the second beam, and the first beam and the second beam have different carrier bandwidths, or the first beam and the second beam have different BWPs; and
determining based on the third indication information and a resource allocated to the communication apparatus, a subsequence that is of the first reference signal and that is occupied by the communication apparatus.

5. The communication method according to claim 1, wherein the first indication information is carried by using a system information block (SIB) or downlink control information (DCI).

6. The communication method according to claim 5, further comprising:
receiving fourth indication information broadcast by the network device, wherein the fourth indication information indicates a configuration parameter of a beam-level update period of the signaling.

7. The communication method according to claim 6, wherein the beam-level update period of the signaling is determined by using the following formula:
$$m = M * D / N ,$$
wherein
m represents an update period, m is in a unit of a quantity of radio frames rf, M represents a beam-level update period coefficient, a value of M is 2^{X1}, X1 is an integer greater than 1, D represents a beam-level paging cycle, a value of D is 32 rf, a value of N is 2^{L}, and L is a positive integer; or
the beam-level update period of the signaling is determined by using the following formula:
$$m = M * D ,$$
wherein
m represents an update period, m is in a unit of a quantity of radio frames rf, M represents a beam-level update period coefficient, a value of M is 1 or ½^{L}, D represents a beam-level paging cycle, and a value of D is 32 rf; or
a value of M is 2^{X1}, X1 is an integer greater than 1, D represents a beam-level paging cycle, and a value of D is at least one of the following:
1 rf, 2 rf, 4 rf, 8 rf, or 16 rf.

8. A communication apparatus comprising:
at least one processor, wherein when the at least one processor executes instructions, the communication apparatus is caused to:
receive first indication information broadcast by a network device, wherein the first indication information indicates configuration information of a first reference signal that corresponds to a first beam and information about a first antenna port number that corresponds to the first beam; and
determine the first reference signal based on the first indication information.

9. The communication apparatus according to claim 8, wherein the communication apparatus is further caused to:
determine based on a resource offset between a resource allocated to the communication apparatus and a reference resource, a subsequence that is of the first reference signal and that is occupied by the communication apparatus, wherein the reference resource is a common reference point of a resource block grid or a starting position of a bandwidth part (BWP).

10. The communication apparatus according to claim 8, wherein the communication apparatus is further caused to:
receive second indication information broadcast by the network device, wherein the second indication information indicates the communication apparatus to determine a sequence of a reference signal based on a reference resource offset, and the reference resource is a common reference point of a resource block grid or a starting position of a bandwidth part (BWP); and
determine based on a resource offset between a resource allocated to the communication apparatus and a reference resource, a subsequence that is of the first reference signal and that is occupied by the communication apparatus.

11. The communication apparatus according to claim 8, wherein the communication apparatus is further caused to:
receive third indication information broadcast by the network device, wherein the third indication information indicates a resource offset between the first beam and a second beam, the resource offset indicates a resource offset between a common reference point of a resource block grid of the first beam and a common reference point of a resource block grid of the second beam, or a resource offset between a starting position of a bandwidth part (BWP) of the first beam and a starting position of a BWP of the second beam, and the first beam and the second beam have different carrier bandwidths, or the first beam and the second beam have different BWPs; and
determine based on the third indication information and a resource allocated to the communication apparatus, a subsequence that is of the first reference signal and that is occupied by the communication apparatus.

12. The communication apparatus according to claim 8, wherein the first indication information is carried by using a system information block (SIB) or downlink control information (DCI).

13. The communication apparatus according to claim 12, wherein the communication apparatus is further caused to:
receive fourth indication information broadcast by the network device, wherein the fourth indication information indicates a configuration parameter of a beam-level update period of the signaling.

14. The communication apparatus according to claim 13, wherein the beam-level update period of the signaling is determined by using the following formula:
$$m = M * D / N ,$$
wherein
m represents an update period, m is in a unit of a quantity of radio frames rf, M represents a beam-level update period coefficient, a value of M is 2^{X1}, X1 is an integer greater than 1, D represents a beam-level paging cycle, a value of D is 32 rf, a value of N is 2^{L}, and L is a positive integer; or
the beam-level update period of the signaling is determined by using the following formula:
$$m = M * D ,$$
wherein
m represents an update period, m is in a unit of a quantity of radio frames rf, M represents a beam-level update period coefficient, a value of M is 1 or ½^{L}, D represents a beam-level paging cycle, and a value of D is 32 rf; or
a value of M is 2^{X1}, X1 is an integer greater than 1, D represents a beam-level paging cycle, and a value of D is at least one of the following:
1 rf, 2 rf, 4 rf, 8 rf, or 16 rf.

15. A non-transitory computer-readable storage medium storing computer instructions that, when executed by a processor, cause a communication apparatus to:
receive first indication information broadcast by a network device, wherein the first indication information indicates configuration information of a first reference signal that corresponds to a first beam and information about a first antenna port number that corresponds to the first beam; and
determine the first reference signal based on the first indication information.

16. The non-transitory computer-readable storage medium according to claim 15, wherein the communication apparatus is further caused to:
determine based on a resource offset between a resource allocated to the communication apparatus and a reference resource, a subsequence that is of the first reference signal and that is occupied by the communication apparatus, wherein the reference resource is a common reference point of a resource block grid or a starting position of a bandwidth part (BWP).

17. The non-transitory computer-readable storage medium according to claim 15, wherein the communication apparatus is further caused to:
receive second indication information broadcast by the network device, wherein the second indication information indicates the communication apparatus to determine a sequence of a reference signal based on a reference resource offset, and the reference resource is a common reference point of a resource block grid or a starting position of a bandwidth part (BWP); and
determine based on a resource offset between a resource allocated to the communication apparatus and a reference resource, a subsequence that is of the first reference signal and that is occupied by the communication apparatus.

18. The non-transitory computer-readable storage medium according to claim 15, wherein the communication apparatus is further caused to:
receive third indication information broadcast by the network device, wherein the third indication information indicates a resource offset between the first beam and a second beam, the resource offset indicates a resource offset between a common reference point of a resource block grid of the first beam and a common reference point of a resource block grid of the second beam, or a resource offset between a starting position of a bandwidth part (BWP) of the first beam and a starting position of a BWP of the second beam, and the first beam and the second beam have different carrier bandwidths, or the first beam and the second beam have different BWPs; and
determine based on the third indication information and a resource allocated to the communication apparatus, a subsequence that is of the first reference signal and that is occupied by the communication apparatus.

19. The non-transitory computer-readable storage medium according to claim 15, wherein the first indication information is carried by using a system information block (SIB) or downlink control information (DCI).

20. The non-transitory computer-readable storage medium according to claim 19, wherein the communication apparatus is further caused to:
receive fourth indication information broadcast by the network device, wherein the fourth indication information indicates a configuration parameter of a beam-level update period of the signaling; wherein the beam-level update period of the signaling is determined by using the following formula:
$$m = M * D / N ,$$
wherein
m represents an update period, m is in a unit of a quantity of radio frames rf, M represents a beam-level update period coefficient, a value of M is 2^{X1}, X1 is an integer greater than 1, D represents a beam-level paging cycle, a value of D is 32 rf, a value of N is 2^{L}, and L is a positive integer; or
the beam-level update period of the signaling is determined by using the following formula:
$$m = M * D ,$$
wherein
m represents an update period, m is in a unit of a quantity of radio frames rf, M represents a beam-level update period coefficient, a value of M is 1 or ½^{L}, D represents a beam-level paging cycle, and a value of D is 32 rf; or
a value of M is 2^{X1}, X1 is an integer greater than 1, D represents a beam-level paging cycle, and a value of D is at least one of the following:
1 rf, 2 rf, 4 rf, 8 rf, or 16 rf.
